(19) United States
(12) Patent Application Publication
(10) Pub. No.: US 2010/0018365 A1
(43) Pub. Date: Jan. 28, 2010

(54) REMOVABLE CLAMPING MEMBER

(75) Inventor: Terance P. TYLER, Strong, ME (US)

Correspondence Address: ANTHONY D. PELLEGRINI RUDMAN & WINCHELL, LLC, 84 HARLOW STREET, P.O. BOX 1401, BANGOR, ME, 04402-1401, US

(73) Assignee: Maine Land Research & Development , Inc.

(21) Appl. No.: 12/546,032

(22) Filed: Aug. 24, 2009

Related U.S. Application Data
(63) Continuation-in-part of application No. 12/179,027, filed on Jul. 24, 2008, now abandoned.

(51) Int. Cl. B25B 5/16

(52) U.S. Cl. 81/423; 269/276; 269/280

(57) ABSTRACT

An improved, removable clamping member for use with clamping devices, said clamping members configured in unlimited variations of shape, texture, and hardness and optionally being moveable relative to the jaws of the clamping devices. The improvements allow increased flexibility of use of the clamping devices over traditionally configured clamping devices with regard to difficult work pieces and environments. The interchangeable clamping members allow a single clamping device to be used for multiple applications, thereby making the invention a low cost and convenient alternative to multiple special purpose tools, as well as permitting quick and inexpensive replacement of wear elements.

### CROSS REFERENCE TO RELATED APPLICATION

This application is a continuation in part of U.S. Ser. No. 12/179,027, filed Jul. 24, 2008 and currently pending, entitled Removable Clamping Member, by Tyler, Terence P., which is hereby incorporated by reference. This application further claims priority to U.S. Pat. No. 7,415,912 (U.S. Ser. No. 11/284,952), filed Nov. 22, 2005 and issued on Aug. 26, 2008, entitled Locking Clamp Device, by Tyler, Terence P., which is hereby incorporated by reference. This application further claims priority to a provisional application, U.S. Ser. No. 60/714,030, filed Sep. 2, 2005, entitled Locking Clamp Device, by Tyler, Terence P., which is hereby incorporated by reference.

### BACKGROUND OF THE INVENTION

1. Technical Field

The invention relates generally to the field of hand tools. More specifically, the invention is directed to an improved clamping member to be used with clamping devices, said clamping members suitable for use with difficult work pieces and environments.

2. Description of Prior Art

Clamping devices are well-known in the art. Vise-Grip™ brand locking pliers are an example. Such clamping devices include a handle mechanism and a clamping mechanism manipulated by the handle mechanism. There many different known methods for implementing these basic structures, for which myriad patents have been issued. The great majority of these prior patents involve various improvements or modifications to the locking mechanisms of the clamping devices.

Other patents are closer in concept to the present invention, though remain distinguishable. Stahle, U.S. Pat. No. 6,308,597 (Oct. 30, 2001), for LOCKING DEVICE FOR A HAND TOOL, discloses a locking clamp having interchangeable clamping surfaces in the form of collet jaws. These are described as having a rib which fits into a channel formed into the end of the jaw of the clamp; the various collet jaws may be slid into and out of the channel to quickly change the function of the clamp. The collect jaws may also pivot. This differs from the present invention in that the collet jaws are not variously shaped or contoured to accommodate different work piece surfaces, and they cannot be rotated relative to the jaws. Bogert, et al., U.S. Pat. No. 4,896,661 (Jan. 30, 1990), for MULTI PURPOSE ORTHOPEDIC RATCHETING FORCEPS, discloses locking surgical forceps having readily interchangeable tips, said tips able to be rotated along the axis of the arm. However, the clamping tips cannot pivot and are not resilient or contoured. Hopper, et al., U.S. Pat. No. 6,860,179 (Mar. 1, 2005), for CLAMP DEVICE, discloses clamping surfaces which may be removed from the jaws. These removable clamping surfaces are designed as wear items and are not intended to be interchanged with different clamping surfaces during use to accommodate different work pieces. Hopper, et al., does not teach the use of differently shaped clamping surfaces, variable materials for clamping surfaces, or the concept of positional clamping surfaces. Reiter, U.S. Pat. No. 3,779,108 (Dec. 18, 1973), for CLAMP, discloses a variation of a spring clamp, with gripping surfaces pivoting in one dimension and with the arms of the jaws themselves rotating. The Reiter clamp also discloses resilient pads covering the clamping surfaces. These are not interchangeable, however, nor are the clamping surfaces of diverse shapes.

Other patents disclose individual concepts similar to the present invention, but represent inferior solutions. Swanstrom, Jr., U.S. Pat. No. 6,748,830 (Jun. 15, 2004), for THREADED GRIPPING BAR PLIERS INSERT, discloses replaceable clamping surfaces. However, these clamping surfaces are replaced only as wear items, are fixed when in use, and are not intended for quick release or interchangeability during use. Domenge, U.S. Pat. No. 6,401,578 (Jun. 11, 2002) and U.S. Pat. No. 6,389,936 (May 21, 2002), for HAND TOOL HAVING PIVOTING HANDLES, disclose pliers with pivoting contact elements on the jaws. These are fixed onto the jaws, and designed to grip only six-sided fasteners. Tally, U.S. Pat. No. 6,134,993 (Oct. 24, 2000), for PLIERS WITH ADJUSTABLE JAWS, discloses pliers with jaws that may be oriented in various positions relative to the handles. This patent discloses soft clamping surfaces, though these are in fact simply vinyl jaw covers placed over the gripping surfaces to protect the work piece. They are not designed to be readily interchanged for use with different types of work pieces. Wolff, et al., U.S. Pat. No. 5,791,210 (Aug. 11, 1998), for SPRING-TENSIONING PLIERS, discloses pivoting clamping surfaces, similar to the pivoting clamping surfaces disclosed in Reiter. However, the clamping surfaces are not interchangeable and pivot in one dimension only. Shin, et al., U.S. Pat. No. 4,133,519 (Jan. 9, 1979), for VISE WITH SELECTABLE JAW FACES, discloses the use of interchangeable clamping surfaces to be used with different types of work pieces. However, the mechanism for changing the clamping surfaces is a disk which is rotated to position the desired clamping surface for use. This is limited to just a few different clamping surfaces. Moreover, the mechanism is not suitable for use in a hand tool.

None of the disclosed prior art offers all of the functionality disclosed in the present invention. Moreover, the implementation of similar individual concepts in earlier patents differs significantly with the implementation of the present invention. Thus none of the disclosed prior art anticipates the present invention.

It is an objective of the present invention to provide useful, improved interchangeable clamping members for use with clamping devices.

It is a further objective of the present invention to provide useful, improved clamping members moveable relative to the jaws of the clamping device to better accommodate work pieces.

It is a further objective of the present invention to provide useful, improved clamping members with various shapes suitable for use with difficultly situated work pieces.

It is a further objective of the present invention to provide a useful, improved magnetic clamping members to hold onto a ferro-metallic work piece.

It is a further objective of the present invention to provide a useful, improved clamping members with positionable attachment components to better accommodate a work piece.

It is a further objective of the present invention to provide a useful, improved telescoping adapter for clamping members.

Other objectives of the present invention will be readily apparent from the description that follows.

### SUMMARY OF THE INVENTION

The preferred embodiment of the present invention is an improved removable clamping member for use with a clamping device having a handle assembly suitably adapted to be held and manipulated by a human hand, and a clamping assembly having jaws suitably adapted to engage a work piece. The clamping member is removably attached to a jaw of the clamping device, preferably with two clamping members used, one each for each of a pair of jaws. The clamping members are suitably adapted to engage with a work piece. The clamping members may pivot or may rotate along an axis perpendicular to the longitudinal axis of the corresponding jaw, to provide greater flexibility in gripping difficultly shaped work pieces. The clamping members may have removable surfaces to act as wear items. The clamping members may also be configurable in any number of shapes, textures, and hardnesses. The clamping members may also be magnetic to hold onto a ferro-metallic work piece. The clamping members may also comprise positionable attachment components to better accommodate a work piece. The clamping members may also comprise telescoping adapters.

Other features and advantages of the invention are described below

### DESCRIPTION OF THE DRAWINGS

FIG. 1 is a plan view of the clamping members shown attached to a clamping device, with a work piece.

FIG. 2A is a perspective view of an embodiment of the attachment component employing a ratchet mechanism.

FIG. 2B is a plan view of an embodiment of the attachment component of the clamping member.

FIG. 3 shows various configurations of the clamping members, including clamping members with clip-on clamping surfaces.

FIG. 4 shows various configurations of the clamping members, including clamping member extension adapters for use with multiple clamping members.

FIG. 5 is a perspective side view of one embodiment of an attachment component.

FIG. 6 is a perspective side view of an embodiment of a positionable attachment component having a pivoting and locking feature.

### DETAILED DESCRIPTION OF THE INVENTION

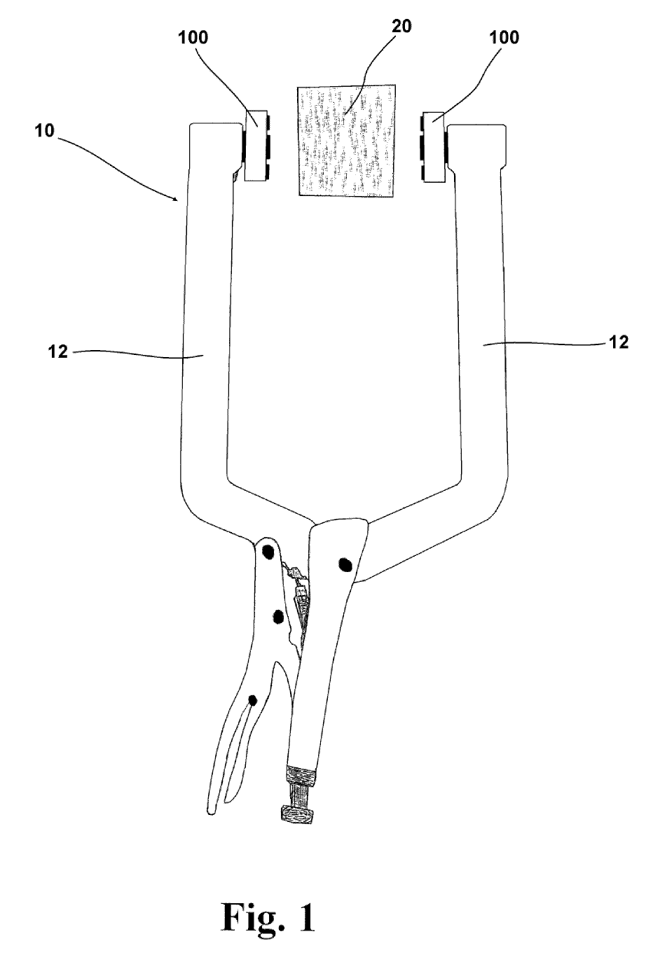

The present invention is directed to an improved clamping member 100 to be used with clamping devices 10. Each clamping member 100 comprises an attachment component 110 suitably adapted to removably attach the clamping member 100 to the ends of a jaw 12 of the clamping device 10. See FIG. 1.

The clamping member 100 is suitably adapted to engage with a work piece 20. See FIG. 1. The ability to remove the clamping members 100 from the jaws 12 of the clamping device 10 allows for the interchangeability of clamping members 100 to suit different purposes. In the present invention the attachment component 110 of the clamping member 100 is suitably adapted to function as a “quick release” mechanism to allow for the removal and attachment of clamping members 100 quickly and easily without the need to use tools.

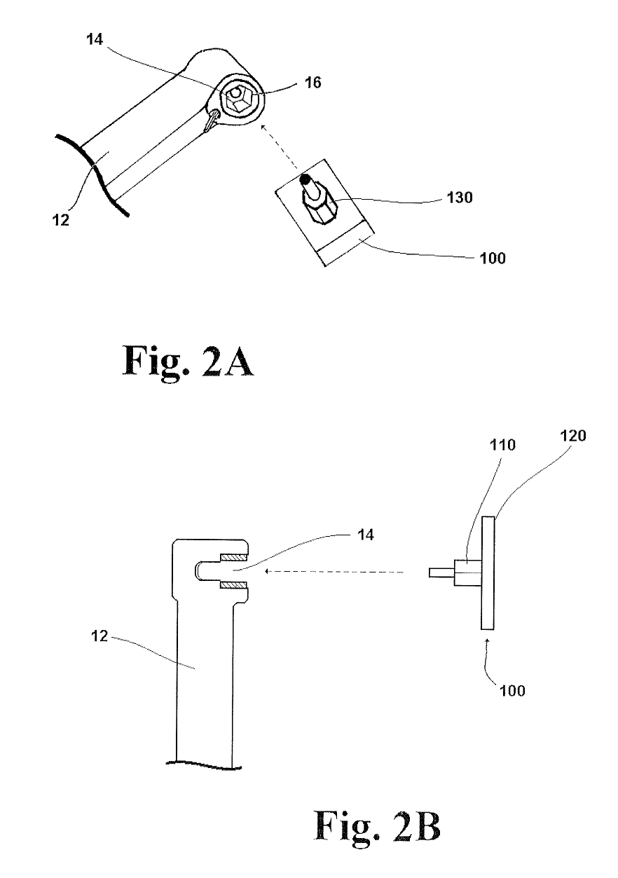

One embodiment of the attachment component 110 comprises an attachment end 130 of the clamping member 100 and an aperture 14 formed into the end of the jaw 12 of the clamping device 10. See FIG. 2B. The aperture 14 is suitably adapted to accommodate the attachment end 130 of the clamping member 100, and the attachment end 130 of the clamping member 100 is suitably adapted to be inserted into the aperture 14.

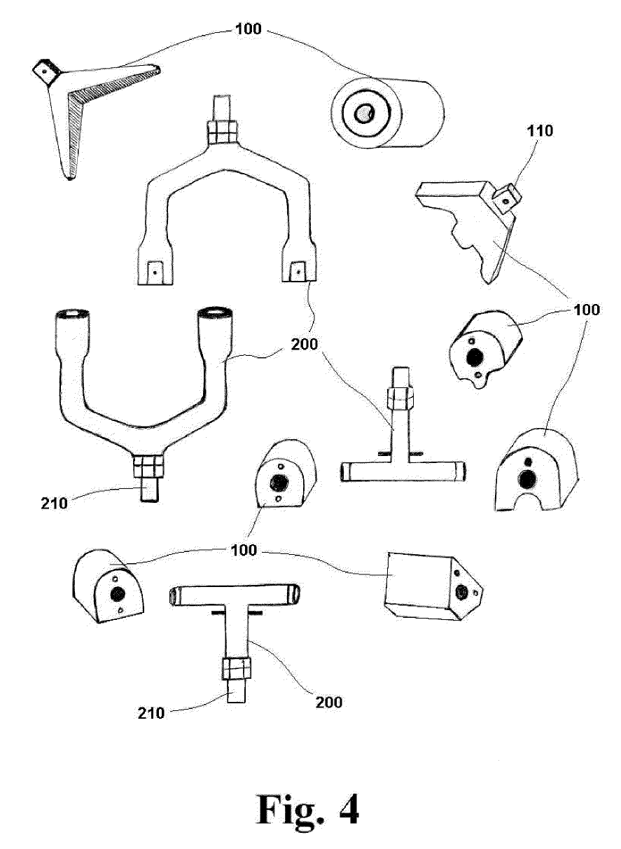

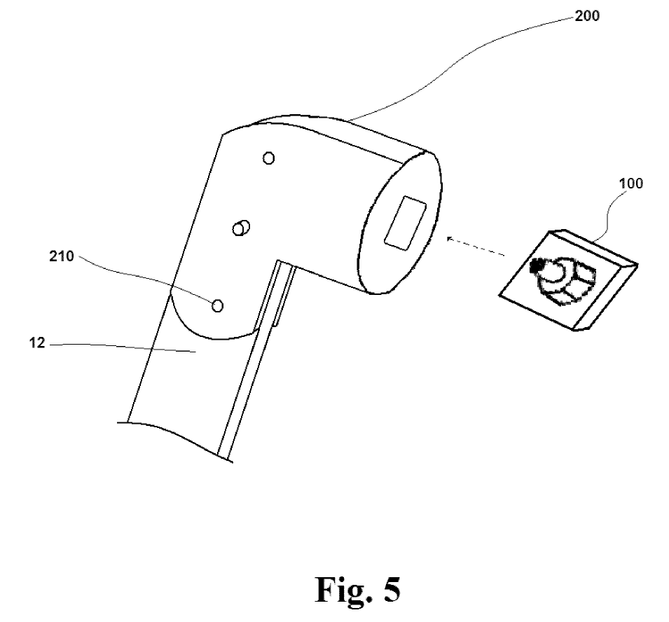

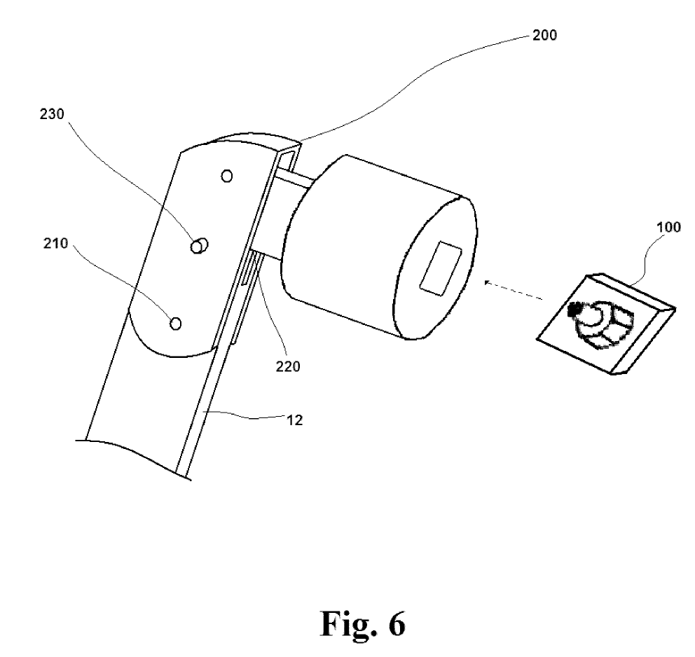

In an alternative embodiment, multiple clamping members 100 may be used with each jaw 12 by use of a clamping member extension adapter 200. See FIG. 4. The clamping member extension adapter 200 is suitably adapted to be removably attached to the clamping device 10 by an adapter attachment component 210. The clamping member extension adapter 200 is interposed between the end of the jaw 12 and the clamping member 100, and has multiple attachment points to accommodate multiple clamping members 100.

In one variation of the present invention the clamping member extension adapter 200 pivots relative to the respective jaw 12 of the clamping device 10. The pivot mechanism 220 allowing the clamping member extension adapter 200 to pivot relative to the respective jaw 12 of the clamping device 10 may be of any suitable configuration. For example, the clamping member extension adapter 200 may be comprised of a first body and a second body, wherein the first body is suitably adapted to accommodate the attachment component 110 of the clamping member 100 and the second body is suitably adapted to attach the clamping member extension adapter 200 to the jaw 12 of the clamping device 10. A horizontal pin secured to the second body and passed through an aperture in the first body would then serve as a fulcrum about which the clamping member extension adapter 200 may pivot. Other configurations are also contemplated. The clamping member extension adapter 200 may further comprise a locking mechanism 230 capable of establishing a locked state and an unlocked state of the clamping member extension adapter 200, wherein the locking mechanism 230 in the locked state is suitably adapted to secure the clamping member 100 in a fixed orientation relative to the clamping device 10 and said locking mechanism in the unlocked state is suitably adapted to permit the clamping member 100 to pivot relative to the clamping device 10. Again, any suitable configuration of the locking mechanism 230 may be used. One such configuration may comprise a locking pin passing through apertures formed within the first body and the second body. The locking mechanism 230 may also be achieved by any other suitable means known in the art.

In yet another embodiment of the present invention, the clamping member extension adapter 200 may be shortened or lengthened in a telescoping manner. In this embodiment the clamping member extension adapter 200 is comprised of a proximate end and a distal end, wherein the distal end of the clamping member extension adapter 200 engages with the proximate end of the clamping member extension adapter 200 in a telescoping manner. That is, the distal end of the clamping member extension adapter 200 is slidably positionable relative to the proximate end of the clamping member extension adapter 200 to either shorten or lengthen the overall length of the clamping member extension adapter 230. The distal end may be frictionally secured in a desired position relative to the proximate end. Alternatively, the distal end may be mechanically secured in a desired position relative to the proximate end using an arm securing mechanism. If the distal and proximate ends are mechanically secured, one embodiment of the arm securing mechanism comprises a threaded aperture in the surface of the proximate end, together with a threaded bolt suitably adapted to be inserted into the threaded aperture and tightened and loosened by being rotated by a human hand, such that when tightened the threaded bolt passes through the proximate end to securely engage the distal end. In yet another embodiment, the clamping member extension 230 adapter further comprises one or more intermediate sections, each said intermediate section interposed between the distal end of the clamping member extension adapter 200 and the proximate end of the clamping member extension adapter 200, such that the distal end and the one or more intermediate sections are slidably positionable relative to each other and to the proximate end to either shorten or lengthen the overall length of the clamping member extension adapter 230. The distal end and the one or more intermediate sections may be frictionally secured in a desired position relative to the proximate end; alternatively, the distal end and the one or more intermediate sections may be mechanically secured in a desired position relative to the proximate end using an arm securing mechanism, as described above.

In another variation of the present invention the clamping member 100 itself pivots relative to its respective jaw 12 of the clamping device 10. The pivoting motion may be in one direction only, such as up and down or side to side, as may be achieved by use of an axle configuration, or the pivoting motion may be in multiple directions, such as may be achieved by a ball joint. The pivoting motion may also be achieved by any other suitable means known in the art.

In another variation of the present invention the clamping member 100 rotates relative to its respective jaw 12 of the clamping device 10. Rotation is along an axis perpendicular to a longitudinal axis of the jaw 12. One embodiment of this variation has the attachment component 110 comprising a ratchet mechanism 16 formed into the end of the jaw 12 of the clamping device 10. See FIG. 2A. The ratchet mechanism 16 has an inner cavity and a toothed ring, with the toothed ring suitably adapted to rotate within the inner cavity of the ratchet mechanism 16. In this embodiment the clamping member 100 has a clamping surface 120 suitably adapted to engage with a work piece 20 and an attachment end 130 opposite the clamping surface 120. The attachment end 130 of the clamping member 100 is inserted into the inner cavity of the corresponding ratchet mechanism 16, with the toothed ring of the ratchet mechanism 16 securing the attachment end 130 of the clamping member 100. Rotation of the toothed ring within the ratchet mechanism 16 effects the relative rotation of the clamping member 100.

In yet a further variation the ratchet mechanism 16 of the attachment component 110 comprises a three-position switch, with the first position of the switch permitting the ratchet mechanism 16 to rotate 360° in a first direction, the second position of the switch permitting the ratchet mechanism 16 to rotate 360° in a second direction opposite the first direction, and the third position of the switch locking the ratchet mechanism 16, preventing rotation. In yet a further variation the ratchet mechanism 16 comprises a two-position switch, with the two positions corresponding to the first two switch positions described above.

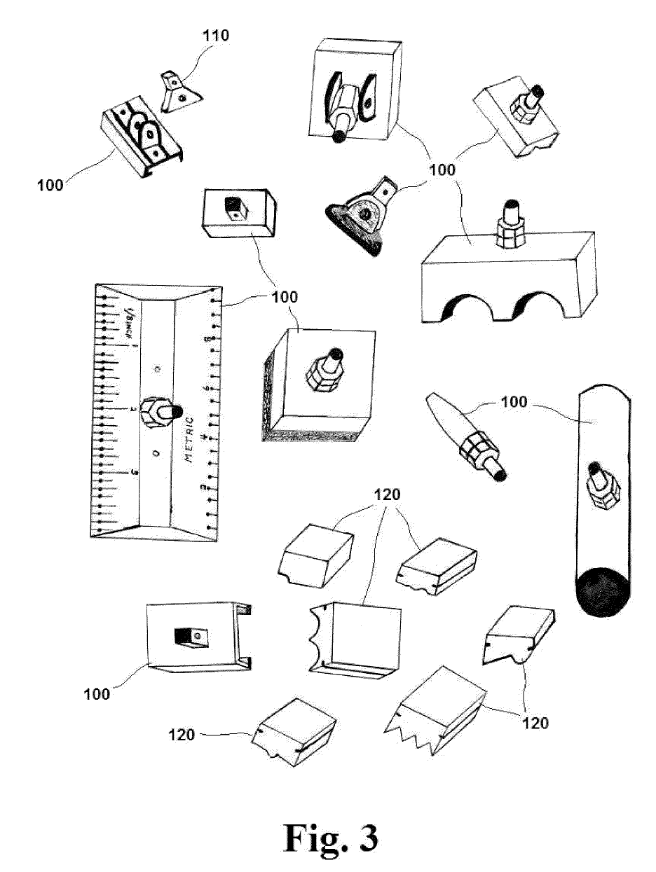

The clamping members 100 may have clamping surfaces 120 of various hardnesses, textures, and shapes. The clamping surfaces 120 may be made of a hard, inflexible material, such as tempered steel, or a soft, flexible material, such as a polymer plastic. The clamping surfaces 120 may be substantially planar. The clamping surfaces 120 may be substantially concave. The clamping surfaces 120 may be substantially convex. The clamping surfaces 120 may be irregularly shaped. See FIGS. 3 and 4. The clamping surfaces 120 may be constructed of a non-stick compound to better enable the clamping device 10 to be used with adhesives. A pair of clamping members 100 need not have clamping surfaces 120 with the same hardness, texture, or shape. The clamping members 100 may further comprise removable clamping surfaces 120, whereby the clamping surfaces 120 may be clipped on and off the clamping members 100. See FIG. 3. This embodiments permits reusable clamping surfaces 120 for applications where they are prone to damage or wear. The ability to interchange clamping members 100 having various hardnesses, textures, and shapes allows clamping devices 10 to be used in a wide range of applications. One such application is for automobile body work, where the various body panels of the automobile have different shapes. Clamping members 100 may be designed to fit specific body panels from various automobile manufacturers so that the panels may be held securely and without damage.

The potentially unlimited range of shapes, textures, and hardnesses of the clamping surfaces 120 of the clamping members 100 provides virtually unlimited uses for the present invention.

In another embodiment of the present invention the clamping member 100 comprises a magnetic clamping surface 120. This enables a ferro-metallic work piece to be engaged by the clamping device 10 while the clamping device 10 is in an opened position, either to hold the work piece 20 or to attach the clamping device 10 to the work piece 20. This permits accurate placement of the clamping device 10 in relation to the work piece 20 prior to setting the clamping device 10 to a closed position. When multiple clamping devices 10 are being used on a ferro-metallic work piece 20, this allows for whatever readjustments are necessary to optimally position all such clamping devices 10, before setting them all to the closed position to secure the work piece 20. An example of this use in is the auto body repair field, where a body panel that is to be bonded to another body panel must be quickly positioned after application of an adhesive; by magnetically attaching multiple clamping devices 10 set in their open positions in the correct orientations on the first body panel in advance, the second body panel can be quickly clamped in the correct orientation immediately after application of the adhesive.

The magnetic clamping surface 110 preferably includes a rare-earth-element magnet. The rare-earth-element magnet should have the holding power to support a load of at least eight ounces on a vertical surface, or to support a load of at least one hundred fifty percent (150%) of the weight of the clamping device 10. In the most preferred embodiment the rare-earth-element magnet is a nickel-coated neodymium-iron-boron magnet with an energy product of at least 25 BH.

In yet another embodiment of the present invention the attachment component 110 of the clamping member 100 comprises magnet. The magnet allows the attachment component 110 of the clamping member 100 to be magnetically secured to the clamping device 10. In a preferred embodiment the magnet is a rare-earth-element magnet. In the most preferred embodiment the rare-earth-element magnet is a nickel-coated neodymium-iron-boron magnet with an energy product of at least 25 BH.

Modifications and variations can be made to the disclosed embodiments of the invention without departing from the subject or spirit of the invention.

I claim:

1. A clamping member suitably adapted to be removably attached to a clamping device by an attachment component, with said clamping member suitably adapted to engage with a work piece.

2. The clamping member of claim 1, said clamping member suitably adapted to pivot relative to the clamping device.

3. The clamping member of claim 1, said clamping member suitably adapted to rotate relative to the clamping device.

4. The clamping member of claim 1 comprising
a clamping surface suitably adapted to engage with a work piece, and
an attachment end opposite the clamping surface.

5. The clamping member of claim 1 comprising a clamping surface suitably adapted to engage with a work piece, said clamping surface being made of either
a hard, inflexible material or
a soft, flexible material.

6. The clamping member of claim 1 comprising
a substantially planar clamping surface suitably adapted to engage with a work piece or
a substantially concave clamping surface suitably adapted to engage with a work piece or
a substantially convex clamping surface suitably adapted to engage with a work piece or
an irregularly shaped clamping surface suitably adapted to engage with a work piece.

7. The clamping member of claim 1 comprising a clamping surface suitably adapted to engage with a work piece, said clamping surface suitably adapted to be removably attached to the clamping member.

8. The clamping member of claim 1 comprising a clamping member extension adapter, said clamping member extension adapter suitably adapted to be removably attached to the clamping device by an adapter attachment component and suitably adapted to accommodate the attachment component of the clamping member such that the clamping member is removably attached to the clamping member extension adapter.

9. The clamping member of claim 8 wherein the clamping member extension adapter is suitably adapted to accommodate the attachment component of multiple clamping members such that each of the multiple clamping members is removably attached to the clamping member extension adapter.

10. The clamping member of claim 8, wherein said clamping member extension adapter is suitably adapted to pivot relative to the clamping device.

11. The clamping member of claim 10, wherein said clamping member extension adapter further comprises a locking mechanism having a locked state and an unlocked state, wherein said locking mechanism in the locked state is suitably adapted to secure the clamping member in a fixed orientation relative to the clamping device and said locking mechanism in the unlocked state is suitably adapted to permit the clamping member to pivot relative to the clamping device.

12. The clamping member of claim 8 wherein the clamping member extension adapter is comprised of a proximate end and a distal end,
wherein the distal end of the clamping member extension adapter engages with the proximate end of the clamping member extension adapter in a telescoping manner, such that the distal end of the clamping member extension adapter is slidably positionable relative to the proximate end of the clamping member extension adapter to either shorten or lengthen the overall length of the clamping member extension adapter.

13. The clamping member of claim 12 wherein the clamping member extension adapter further comprises one or more intermediate sections, each said intermediate section interposed between the distal end of the clamping member extension adapter and the proximate end of the clamping member extension adapter, such that the distal end of the clamping member extension adapter and the one or more intermediate sections are slidably positionable relative to each other and to the proximate end of the clamping member extension adapter to either shorten or lengthen the overall length of the clamping member extension adapter.

14. The clamping member of claim 4, wherein the clamping surface is magnetic and is suitably adapted to securely hold a ferro-metallic work piece when the clamping device is in an opened position or to securely hold the clamping device to the ferro-metallic work piece when the clamping device is in an opened position.

15. The clamping member of claim 14, wherein the clamping surface includes a rare-earth-element magnet.

16. The clamping member of claim 15, wherein the rare-earth-element magnet is a nickel-coated neodymium-iron-boron magnet with an energy product of at least 25 BH.

17. The clamping member of claim 15, wherein the rare-earth-element magnet has holding power to support a load of at least the greater of eight ounces on a vertical surface or one hundred fifty percent of the weight of the clamping device.

18. The clamping member of claim 1 wherein the attachment component comprises a magnet suitably adapted to magnetically secure the clamping member to the clamp device.

19. The clamping member of claim 18, wherein the attachment component comprises a rare-earth-element magnet.

20. The clamping member of claim 19, wherein the rare-earth-element magnet is a nickel-coated neodymium-iron-boron magnet with an energy product of at least 25 BH.
